(19) United States
(12) Patent Application Publication
(10) Pub. No.: US 2002/0054334 A1
(43) Pub. Date: May 9, 2002

(54) Document transmission Techniques I

(76) Inventors: Keith Alexander Harrison, Woodcroft Chepstow (GB); Richard Brown, Frampton Cottrell (GB)

Correspondence Address: HEWLETT-PACKARD COMPANY, Intellectual Property Administration, P.O. Box 272400, Fort Collins, CO, 80527-2400, US

(21) Appl. No.: 09/918,188

(22) Filed: Jul. 30, 2001

(30) Foreign Application Priority Data
Aug. 25, 2000 (GB) 0020873.6

(51) Int. Cl. G06F 15/00

(52) U.S. Cl. 358/1.15

(57) ABSTRACT

A method of delivering a digital document to an intended recipient at a printout station, such as a fax machine. The method comprises receiving and securely retaining a transmitted document and a transmitted independently verifiable data record such as a digital certificate of the intended recipient at the printout station. A first token, such as a public key, of the intended recipient is obtained, usually from the transmitted information. The method includes requesting proof of the intended recipient's identity at the receiving fax machine using data in the digital certificate of the intended recipient and releasing the document when the intended recipient has proved their identity by use of a second token, such as a private key, that is uniquely related to the first token. The private key may be provided on a portable smart card. Also envelope data encryption techniques may be used to add security to the transmission of the document.

### FIELD OF THE PRESENT INVENTION

The present invention concerns improvements relating to document transmission techniques and more specifically, though not exclusively, to a new fax transmission protocol which can be used in conjunction with the existing standard fax protocols to provide additional security in fax transmission and/or delivery. The present invention has application to virtual private networks of document printout machines and can be used in document verification subsequent to a document having been delivered to its intended recipient.

### BACKGROUND TO THE PRESENT INVENTION

The use of fax machines for the transmission of documents is a well established and essential business practice. Even though the advent of computers and the Internet has heralded the advent of electronic document transmission via e-mail, the use of fax machines has not been made redundant. Rather, there are several differences between the use of fax machines and computers that can be advantageous in many circumstances and these have maintained the requirement for fax machines in offices as is explained below.

One of the major distinctions between the use of computers and fax machines for document transmission is seen in that fax machines are often left constantly on-line and are therefore readily accessible whereas computers are often switched off (at night for example). Also at present, e-mail to computers actually has to be retrieved from an ISP (Internet Service Provider) as the e-mail address of the person resides there, whereas for fax documents, the machine itself (at the user's location) receives and prints out the document directly to the recipient. Furthermore, the cost of a computer, a printer (required for a hard copy of the document) and a scanner (required for making an electronic copy of a paper document) is far more than that of a fax machine which can incorporate simple modem, scanning and printing technology. This has been a significant factor in the greater ownership of fax machines than computers all over the world.

Whilst fax machines clearly have their niche in office communications, there is however, an inherent lack of security in this way of document transmission. More specifically, a person wishing to intercept the fax transmission could do so without great difficulty and could reassemble the serial bits of the fax message to recreate the document being faxed. Also, the incorrect dialing of a fax number and the resultant sending of the document to a wrong place can often lose the confidentiality of the transmitted information. The printing out of the document when received at a shared fax machine (such as one at a hotel reception) can also compromise confidentiality if that document is read by an unscrupulous person, for example, prior to its intended recipient reaching the fax machine. Furthermore, there is also no way of knowing for sure where the fax came from (the telephone fax header can easily be altered to reflect a different identity) or of knowing for sure that the fax has been received by the person meant to receive it. Given the present security in fax transmissions, it is even possible for an unscrupulous person to scan electronically someone's written signature, to append this to the document and then to fax the combination as a request for an authorisation to a service (e.g. to sell some shares).

The above lack of security of conventional fax systems has been known for some time now. Over the past several years, in applications where secure document delivery is paramount, there has been a significant trend away from the use of fax machines to the use of secure computer systems and secure e-mail. This has in turn led to loss of the significant advantages associated with the use of relatively simple fax machines as compared with computer/printer/scanner combinations.

### SUMMARY AND OBJECTS OF THE PRESENT INVENTION

It is an object of the present invention to overcome or substantially reduce at least some of the above described problems. It is another object of the present invention to provide an improved document transmission/reception protocol that provides a secure method of communication from party to party.

The present invention aims to increase the confidence in the authenticity of a sent or a received fax document. It is also desired to close at least some of the existing loopholes in document delivery security and to improve the security of fax document transmission generally.

The present invention resides in the appreciation that many of the above described problems with fax document transmission techniques can be solved or substantially reduced by use of authentication techniques with the fax transmission protocols, namely the document being transmitted can be digitally signed in a readily verifiable way.

According to one aspect of the present invention there is provided a method of delivering a digital document to an intended recipient at a printout station, the method comprising: receiving and securely retaining a transmitted document and a transmitted independently verifiable data record of the intended recipient at a printout station; obtaining a first token of the intended recipient; requesting proof of the intended recipient's identity at the printout station using data in the independently verifiable data record of the intended recipient; and releasing the document when the intended recipient has proved their identity by use of a second token that is uniquely related to the first token.

In one embodiment, the retaining step comprises storing the received document in memory without printing out a copy of it on receipt, with a copy only being printed when the releasing step occurs. This provides a very secure way of document delivery and requires only a software modification of the document printout station if it is was conventional fax machine or other printout station. In another embodiment of the present invention, the retaining step comprises printing out the document as received and placing it in a locked compartment. Here the document can be transmitted and printed out as a standard document with the access to the document being controlled.

Preferably, the requesting step comprises requesting supply of data encoded with the second token which can be decoded with the first token. In this way, the document printout station can readily decode user identification data and because of the unique relationship between the first and second tokens the security of the system is maintained.

The releasing step may be carried out when the intended recipient has presented a portable data carrier holding the second token to the printout station and has transferred data to prove their identity. The intended recipient can thus carry around with them the second token which can be used at any document printout machine to verify their identity.

For added security, the releasing step may further comprise the intended recipient entering a verifiable security identifier into the printout station to establish that they are the legitimate owner of the portable data carrier. This security identifier is typically a PIN (Personal Identification Number) though it could also be the biometrics of a person such as a signature or a fingerprint.

The obtaining step may conveniently comprise extracting the first token transmitted with the document and the data record. Also, the intended recipient's independently verifiable data record may be provided as an intended recipients digital certificate, which incidentally would also contain a copy of the first token. This is the most commonly used way of providing information which can be authenticated about a particular individual and has the advantage of enabling the document printout station to validate the identity of any entity at any time as well as providing all of the required information about the recipient or sender together with the first token (a public key when PKI (Public-Key Infrastructure) is being used) in one standard document.

The method may further comprise carrying out an on-line check of the validity of the intended recipient's independently verifiable data record. Whilst this is not necessary for each document received, it can be used as a random check or where there is apparently a higher risk of fraud. However, the method may further comprise instructing a third party to carry out an on-line check of the validity of the intended recipient's independently verifiable data record. This frees up the document printout station to carry out other tasks and more importantly does not engage the communications link into the document printout station for a significant period of time.

The releasing step in this case may further comprise only releasing the document if the validity of the independently verifiable data record has been confirmed as a result of the check. Clearly this would slow down the process, but it would provide one of the highest levels of security for ensuring that the intended recipient is actually who they are claiming to be.

As a further security measure the transmitted document may be encrypted and the method may further comprise decrypting the received document once the intended recipient has proved their identity. This ensures that even if the document is intercepted, that it will not be readily readable. Preferably, enveloping techniques are used to minimise the computational processing time the encryption/decryption techniques take. More specifically, where the transmitted document has been encrypted with a session key and the session key has been encrypted with the first token, the transmitting step preferably comprises transmitting the encrypted session key to the printout station, and the decrypting step preferably comprises decrypting the encrypted session key with the second token and decrypting the received document with the decrypted session key.

It is possible to configure the method of the present invention to work in the following way. The receiving step comprises receiving a plurality of transmitted independently verifiable data records of a plurality of intended recipients at the printout station; the obtaining step comprises obtaining the first tokens of each of the intended recipients; the requesting step comprises requesting proof of each of the intended recipients' identities at the printout station using data in the independently verifiable data records of the intended recipients; and the processing step comprises processing each of the intended recipients' response to the request and releasing the document when all of the intended recipients have proved their identity by use of respective second tokens that are each uniquely related to respective ones of the first tokens. In this way, it is possible to ensure that several people are present when a document is released. This feature can ensure that no one person gains an advantage over another when each person should see the document at about the same time. Also, this feature would provide the necessary means if, for security purposes, all of the members of the group needed to be present in order to access a received document.

With the group feature described above, the transmitted document or a session encryption/decryption key of the transmitted document may have been sequentially encrypted with each of the first tokens of the intended recipients in a given order and the processing step may comprise sequentially decrypting the transmitted document or a session encryption/decryption key with each of the second tokens of the intended recipients in the reverse of the given sequential order.

The present invention also extends to a device for delivering a digital document to an intended recipient, the device comprising: a communications module for receiving an electronic version of the transmitted document over a communications network, an independently verifiable data record of the intended recipient, and a first token of the intended recipient; a store for securely retaining the transmitted document, the transmitted independently verifiable data record and the first token; an instruction module for requesting proof of the intended recipient's identity using data provided in the intended recipient's data record; and a controller for releasing the document when the intended recipient has proved their identity by use of a second token that is uniquely related to the first token.

According to another aspect of the present invention there is provided a method of delivering a digital document from a first station via a communications network to an intended recipient at a second station, the method comprising: obtaining details of the intended recipient, including an independently verifiable data record of the intended recipient at the first station; transmitting the document and the independently verifiable data record of the intended recipient to the second station; receiving and securely retaining the transmitted document and data record at the second station; obtaining a first part of an intended recipient's identifying token at the second station; requesting proof of the intended recipient's identity at the second station using the transmitted independently verifiable data record; and releasing the document to the intended recipient when the intended recipient has proved their identity using a second part of the recipient's identifying token.

The term digital document as used in the present specification is intended to mean a digital representation of a document regardless of the content of the document. The document can contain images or text or both, for example.

The present invention also aims to ensure the identity of an unknown sender of a digital document and the authenticity of the document itself. This is essentially achieved with the use of independently verifiable data records and fingerprints (digests) of the document being sent.

More specifically, according to another aspect of the present invention there is provided a method of determining the authenticity of a digital document sent by an unknown sender, the method comprising: receiving a digital document, an encrypted digest of the document created by the sender using a hash algorithm, the digest being encrypted using a first token of the sender; obtaining a second token relating to the first token; decoding the encrypted digest using the second token; using a hash algorithm to create a digest of the document; and comparing the decrypted received digest with the newly created digest to determine the authenticity of the sender and the document.

The receiving step preferably comprises receiving a digital certificate of the sender for the reasons which have been set out previously. In this case, the second token is preferably conveniently obtained by being sent as part of the sender's digital certificate.

The method may further comprise carrying out an on-line check of the validity of the sender's certificate. This feature provides increased security as the authenticity of the sender can be verified via an independent certificate issuing authority. However, this check can also be carried out by a third party by way of assignment by the document printout station and this in turn ensures that the communications line to the printout station and time of the document printout station is not occupied for a long period of time.

The first and second tokens preferably comprise private and public encryption/decryption keys of the sender. The use of PKI provides a layer of security which ensures that the claimed author of a document is in fact that document's author.

The method may further comprise printing a verifying mark on the printed copy of the document to signify its authenticity. This provides an instantaneous quality assurance mark which can be extremely helpful in reassuring users of the document after it has been transmitted that it is genuine.

According to another aspect of the present invention, there is provided a method of sending a digital document to a recipient together with data enabling the document and the sender to be authenticated, the method comprising: creating a digest of the document using a hash algorithm; encrypting the digest using a first token of the sender; obtaining a second token relating to the first token of the sender, which can be used to decrypt the encrypted digest; sending the encrypted digest, the digital document and the second token to the recipient.

The method may further comprise the sender proving their identity prior to the sending step by transferring data from a personal portable data carrier holding the first token to a transmission station from which the document is to be sent. This portable identity of the sender advantageously enables him or her to use any document transmission station to send a document.

The proving step may further comprise the sender entering a verifiable security identifier into the transmission station to establish that they are the legitimate owner of the portable data carrier. This feature provides further security to prevent stolen portable data carriers from being used, for example.

The step of encrypting the digest may comprise supplying the digest of the document from the transmission station to the portable data carrier of the sender, encrypting the digest of the document on the portable data carrier, and returning the encrypted digest of the document from the portable data carrier to the transmission station. This is how a portable data carrier holding the first token would be used to prove the identity of the sender without compromising the security of the portable data carrier (first token) itself.

The method may further comprise obtaining details of the sender including the second token prior to transmitting the document. These details could be readily obtained from a central directory database, storing second tokens and other sender's details, such as LDAP and so the identification information regarding the sender could be obtained from a trusted up-to-date source. Alternatively, the details could be obtained more quickly from the sender themselves, for example from their portable data store. In either case, the sender's details and the second token could be provided in a sender's digital certificate.

The present invention may also be considered to be a device for determining the authenticity of a digital document sent by an unknown sender, the device comprising: a communications module arranged to receive the document, an encrypted digest of the document created by the sender using a hash algorithm, the digest being encrypted using a first token of the sender, and a second token relating to the first token; and a controller arranged to decode the encrypted digest using the second token; creating a digest of the document using a hash algorithm; and comparing the decrypted received digest with the newly created digest to determine the authenticity of the sender and the document.

The present invention also extends to a device for sending a digital document to a recipient together with data enabling the document and the sender to be authenticated, the device comprising: a controller arranged to create a digest of the document using a hash algorithm and to encrypt the digest using a first token of the sender; and a communications module arranged to obtain a second token related to the first token of the sender, which can be used to decrypt the encrypted digest and to send the encrypted digest, the digital document and the second token to the recipient.

There are many security advantages in having a document printout station that has a sophisticated memory which can provide a memory of the validity of each document page it has printed out.

More specifically, according to another aspect of the present invention there is provided a document printout device for receiving and printing out digital documents, the printout device comprising: a store of digital certificates, each certificate being associated with a received digital document; and an audit log comprising a list of received document entries, each entry containing a reference to one of the certificates in the store and a unique identifier associated with a received digital document.

The device is preferably arranged to carry out an on-line authentication of a received certificate held in the store of received documents. This enables the validity of a digital certificate to be checked either in real time or at a later date or time, if necessary, to confirm the authenticity of the printed out document.

The device may be arranged to carry out a batch of on-line authentications of received certificates held in the store of received documents. This feature provides a way of minimising the amount of on-line time required for self-authentications of the received certificates and also allows them to be carried out at a time when there is less potential traffic conflicts to be considered.

Each entry in the audit log may contain a digest of the received document to which it relates. This is an optimal space saving way of storing each document in the audit log. The reason why the full document is not required is that its use would only be for comparison purposes.

In this regard, the device may further comprise a hash algorithm for creating a digest of a digital document and a receiving module for receiving a digital representation of a previously printed out document, wherein the device is arranged to create a digest of the digital representation of the previously printed out document and to compare the newly created digest with the corresponding digest stored in the audit log. In this way, any printed out document can be verified as having been printed out by a specific device, thereby further helping to reduce opportunity for fraudulent copies of documents.

Preferably, the device is arranged to send either a stored digest or a newly created digest of a document to its original sender and to verify the authenticity of the document back to its source by considering the transmitted results of a comparison of digests carried out at the source. This feature advantageously enables a check on the authenticity of a document to be made right back to its source.

The receiving module may be a document scanning module such that the actual document printed out may be scanned back in for the comparison.

Each entry in the audit log may contain the time and date of receipt of each digital document to further help establish the integrity of the received data when carrying out comparison checks, for example.

The unique identifier is preferably an alphanumeric code and the device preferably further comprises an input module for inputting the code to access the relevant entry in the audit log. This enables stored information about a particular printed out document to be obtained by use of the unique identifier on printed on the document itself. There is no need to have the document present, only the identifier is required. This also enables the exact machine from which a document originated to be identified, such that any further details regarding the document stored at the machine can be accessed.

According to another aspect of the present invention there is provided a method of authenticating the identity of a sender of a received digital document, the method comprising: using a unique identifier printed on the received document to search for a corresponding record in a list of received document records; referencing a digital certificate associated with the selected record, the certificate being one of a store of certificates of received documents; and carrying out an on-line authentication of the certificate.

It is often the case that fax numbers of certain fax machines are only available to several people within an organisation as those fax machines should only to be used for communications from specified sources. However, it is often difficult to ensure that only specified sources will transmit to the fax machine and proving the identity of the source has not been possible before.

It is another objective of the present invention to overcome or substantially reduce the above problem.

According to another aspect of the present invention there is provided a document delivery system operable as a closed group system of a plurality of members, the system comprising: a plurality of document printout machines, each associated with a member of the closed group and being connectable to each other via a communications network, wherein each machine can access a first token unique to its associated member and a second token of each of the closed group's members corresponding to members' first tokens, and wherein each machine comprises a store of all member's independently verifiable data records, and each machine is arranged to access and utilise its first and second tokens and the data records to establish a document printout machine's membership of the closed group prior to transmission or receipt of any digital documents across the network.

In this way, a single fax machine can be configured to operate as part of a virtual private network (VPN) or alternatively as a normal fax machine. When operating as the former of these two, it can effectively screen out digital documents sent to it from other document transmission machines which are not part of the group (VPN).

Each member's stored data record preferably comprises a second token of that member. This makes accessing the second token relatively straightforward as it is provided with the previously obtained data record. Furthermore, the data record preferably comprises a digital certificate of the member issued by a Certification Authority.

At least one of the document printout machines may be arranged to check the validity of a given machine's membership at any time by carrying out an on-line check of the validity of the given machine's independently verifiable data record (digital certificate). The checking of validity of a member's membership is not necessary all the time but advantageously it can be carried out at some time if deemed necessary or as a random spot check by the at least one document printout machine.

The first token of at least one of the members may be provided on a portable data store which is readable by a data store reader of a machine. This enables the at least one member of the closed group to use the same machine as part of a VPN and other people if required to use the fax machine normally without any restriction. This adds to the ways in which the fax machine can be used thereby in some cases obviating the need for another conventional fax machine and its associated cost.

Each document printout machine may be arranged to send and receive Nonces. This advantageously increases security against fraud by preventing replay attacks on the digital data transmissions. In this case, each document printout machine may be arranged to encrypt a Nonce using a second token and to decrypt a Nonce using its associated member's first token.

The present invention also extends to a method of establishing membership of a closed group of document printout machines that can each access a first token unique to a member of the group associated with that machine and a second token of each of the closed group's members corresponding to the members' first tokens, the method comprising: sending from a first document printout machine, an independently verifiable data record of its own information to a second document printout machine; comparing at the second machine the received record with the first machine's stored data record and, if they are identical, sending the second machine's own independently verifiable data record to the first machine; comparing the received second machine's data record with the second machine's stored record and, if they are identical, authenticating the second machine as member of the closed group; and using the first and second tokens to encrypt and decrypt at least some data sent between said members of the group.

The sending step may conveniently comprise sending a second token of a member as part of that member's independently verifiable data record.

The method may further comprise sending and receiving Nonces at the first and second document printout machines. The use of Nonces improves the integrity of the method by preventing replay attacks on the digital data transmissions.

The using step may comprise encrypting a Nonce to be sent using a second token and decrypting a received Nonce using its associated member's first token.

The using step may comprise encrypting and decrypting Nonces of the first and second machines by use of public and private encryption/decryption keys of the first and second members.

As has been mentioned before, the first and second document printout machines may comprise fax machines. However, other printout devices such as computer printers may also be suitable as document printout means.

The method may further comprise authenticating any received independently verifiable data record to establish the authenticity of the data record. This provides an additional check on the identity of a person claiming to be a member and also ensures that if a member's identity has been stolen, that it cannot be used.

The authentication step preferably comprises authenticating the independently verifiable data record on-line as this is a way of determining in real time the authenticity of an entity claiming to be a member.

### BRIEF DESCRIPTION OF THE DRAWINGS

Presently preferred embodiments of the present invention will now be described by way of example with reference to the accompanying drawings. In the drawings:

FIG. 1 is a schematic block diagram showing a system for transmitting faxed document data to an intended recipient according to a first embodiment of the present invention;

FIG. 2a is a flow diagram showing the process of transmitting faxed document data for an intended recipient from a sending fax machine to a receiving fax machine shown in FIG. 1;

FIG. 2b is a flow diagram showing the process of receiving faxed document data for an intended recipient at a receiving fax machine shown in FIG. 1;

FIG. 3 is a schematic representation of a receiving fax machine according to a second embodiment of the present invention;

FIG. 4 is a schematic block diagram showing a system for transmitting and receiving faxed document data from an unknown sender according to a third embodiment of the present invention;

FIG. 5 is a flow diagram illustrating the process of preparing the documentation for transmittal from the sending fax machine shown in FIG. 4;

FIG. 6 is a flow diagram illustrating the process of receiving the faxed documentation at the receiving fax machine of FIG. 4 and confirming the identity of the sender prior to confirming the authenticity of the faxed document;

FIG. 7 is a schematic block diagram showing a virtual private network system of fax machines according to a fourth embodiment of the present invention; and

FIG. 8 is a flow diagram illustrating the process of using the virtual private network system of fax machines shown in FIG. 7.

### DETAILED DESCRIPTION OF THE PRESENTLY PREFERRED EMBODIMENTS

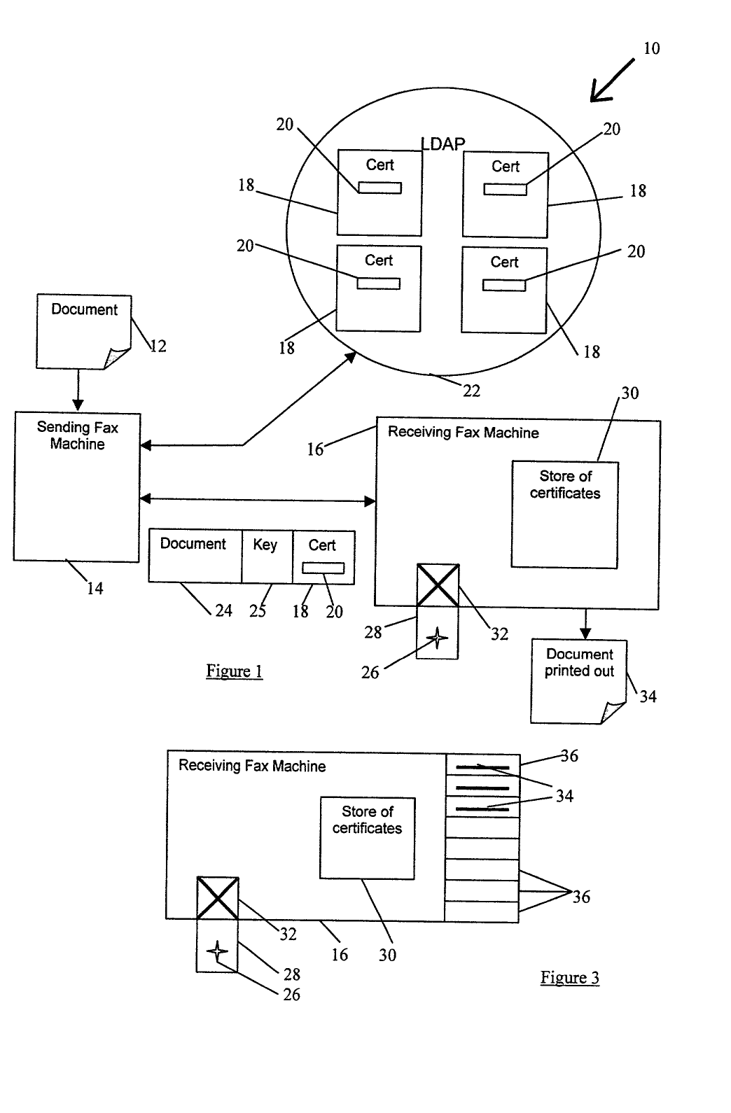

Referring now to FIG. 1 there is shown a fax system 10 according to a first embodiment of the present invention for implementing a new fax protocol which insures that a fax of a document 12 reaches its intended recipient. The fax system 10 comprises a sending fax machine 14 and a receiving fax machine 16. Both machines are able to function as normal fax machines but, in addition to this, are configured to take advantage of a more secure overlay protocol as will be described below.

The secure protocol relies on the use of digital certificates 18 which each contain a copy of a corresponding individual's public key 20. The digital certificates 18 comply with the well known X.509 standard. Public keys 20 of an individual are normally readily accessible within the electronic environment and are well known in the field of public/private key encryption techniques. Accordingly, no further detailed explanation of how these keys operate or of the certificate standard is provided herein.

In the present embodiment, the fax system 10 accesses a central database 22 of individuals' certificates which uses LDAP (Lightweight Directory Access Protocol). The LDAP database 22 is well known and is configured to enable details regarding any registered user to be obtained and provided for use in transmission of the fax to the receiving fax machine 16. In particular, an encrypted fax version 24 of the document 12 (encrypted using a session key 25) is transmitted together with the intended recipient's digital certificate 18, containing the intended recipient's public key 20 and their contact details, and the session key 25 (encrypted using the intended recipient's public key 20).

For each public key 20 stored in the LDAP database 22, there is a corresponding single private key 26 which is owned by the individual themselves. This private key 26 is provided on an intelligent portable store such as a smart card 28, which the individual keeps personal possession of. The smart card 28 not only contains the private key 26, but also an algorithm for encoding or decoding data using the private key 26. The private key 26 enables the intended recipient to uniquely identify themselves to the receiving fax machine 16 in order to received the fax document 24, as will be described in detail later.

The receiving fax machine 16 includes a store 30 which retains each of the received certificates 18 and transmitted fax documents 24 until such time as the intended recipient accesses its transmitted fax document 24. The receiving fax machine 16 also has a smart card reader 32 provided in its housing such that an individual's smart card 28 can be inserted and certain information can be read into the receiving fax machine 16. It is to be appreciated, that the individual's private key 26 is never transmitted to the receiving fax machine 16 as this would compromise the security of the data and the system 10. The details of the interaction between the individual's private key 26 and received fax is also described in detail later.

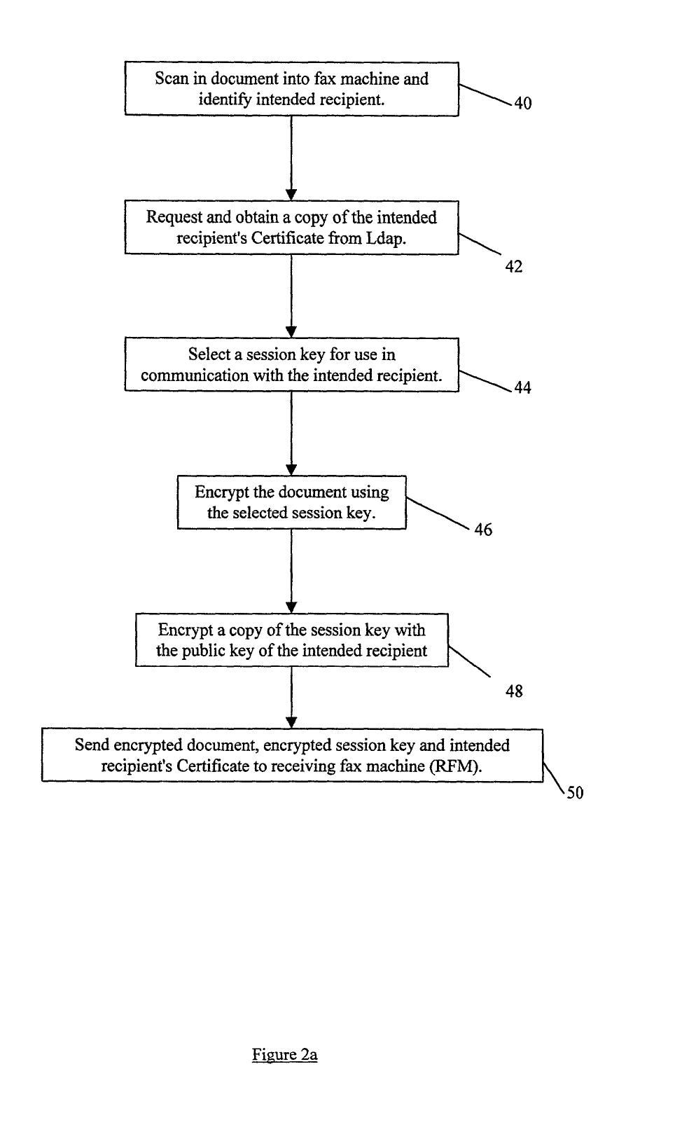

In the present embodiment, the receiving fax machine 16 is configured to receive an encrypted fax document 24, to store the fax document 24 electronically and to print it out as a paper document 34 only when an intended recipient of the fax document 24 has proved their identity by use of their private key 26. The entire process of transmitting a document to an unknown actual recipient (namely the fax machine of an unknown person or authority) for the attention of a specific known person is now described with reference to FIGS. 2a and 2b.

Referring now to FIG. 2a, the process commences with the original document 12 being scanned at 40 into the sending fax machine 14. At this stage, the sender has also to specify the identity of the intended recipient as well as the telephone number of the receiving fax machine 16. Once the identity of the intended recipient has been entered into the sending fax machine 14, the intended recipient's certificate 18 is requested and obtained at 42 from the LDAP database 22.

In order to provide secure communications, resistant to someone tapping into or diverting the fax transmission to access the document, the fax document 24 is encrypted. This is carried out in this embodiment by the use of enveloping encryption techniques. These involve the sending fax machine encrypting the document to be sent using a lightweight encryption algorithm which is computationally inexpensive. DES, Triple DES, RC2 and Skipjack are examples of such lightweight encryption algorithms. An encryption key for the lightweight encryption algorithm is then encrypted using a standard computationally heavyweight encryption algorithm, such as RSA, which uses the intended recipient's public key. The heavily encrypted algorithm key can be decrypted with the intended recipient's private key 26 at the receiving fax machine and used to decode the lightweight coded document.

More specifically, in the present embodiment, the session key 25 which is a coding algorithm key that is unique to the current communication event, is used. The process comprises selecting at 44 a session key 25 for use with the communication with the intended recipient. Then the scanned in document is encrypted at 46 using a relatively lightweight symmetric cryptographic encryption algorithm such as DES for example under the unique selected session key 25.

As the session key 25 also needs to be sent with the encrypted document 24 in order to be able to decode it, the session key 25 is encrypted at 48 using the public key 20 of the intended recipient and the computationally heavy encryption algorithm, e.g. RSA. The public key 20 of the intended recipient is incidentally also found in the intended recipient's Certificate 18. The encoding of the session key 25 ensures that it will only be decodable by the owner of the intended recipient's private key 26.

Once the sending fax machine 14 has created the encrypted version 24 of the scanned-in document 12 and has obtained the digital certificate 18 of the intended recipient, then can be sent to the receiving fax machine 16 together with the encrypted session key 25. However, prior to sending the information, the sending fax machine 14 implements a modified interconnect fax protocol to establish the link between the two machines. The modification over the standard interconnect fax protocol is that the sending fax machine 14 inquires as to whether the receiving fax machine 16 is of the type which can be used according to the present embodiment, namely one which has the capability to stop the faxed document from being printed out until the intended recipient has proved their identity. If the receiving fax machine 16 is a standard machine, this is determined at this stage and the sending fax machine 14 can either not send the fax document 24 or send it as a normal non-encrypted fax, namely without the certificate 18 and session key 25, which will be printed out conventionally. However, if the receiving fax machine 16 is capable of implementing the present invention, then the next stage is to send at 50 the encrypted fax document 24, the intended recipient's certificate 18 and the encrypted session key 25 to the receiving fax machine 16.

Referring now to FIG. 2b, the process of receiving the fax document 24 and providing it to the intended recipient is now described. The receiving fax machine 16 receives at 52 the encrypted fax document 24, the intended recipient's certificate 18 and the encrypted session key 25, and places these in the store 30. The receiving fax machine 16 then requests at 54 the intended recipient to input their smart card 28 (containing their private key 26) into the smart card reader 32. More specifically, this is carried out by the certificate 18, which contains the name of the intended recipient, being extracted from the received information and the name being displayed on the receiving fax machine 16. However, it is to be appreciated there are various different viable ways in which the intended recipient could be notified that there is a fax for them.

In response to the request, the intended recipient inputs their smart card 28 into the card reader 32 of the receiving fax machine 16. The encrypted session key 25 is then passed at 54 from the store 30 to the smart card 28. The decryption algorithm running on the processor of the smart card 28 decrypts at 56 the session key 25 using the private key 26. The decrypted session key 25 is then passed back at 58 to the receiving fax machine 16 and is used to decrypt at 58 the encrypted fax document 24.

By virtue of being able to decode the session key 25 correctly, the intended recipient user has gone a large way to proving their identity to the receiving fax machine 16 and can be permitted to access the fax document 24. However, the use of digital certificates 18 enables an extra level of security to be achieved as is now described.

The process continues with a determination at 60 of whether a verification of the intended user's certificate is required? If the answer is no, then the decrypted fax document 24 is simply printed out at 62 for the intended recipient. However, if verification of the certificate 18 is required at 60, the receiving fax machine 16 carries out an on-line authentication check at 64 of the intended recipient's certificate 18. This on-line check may actually involve authentication of a string of certificates until a trusted authority's certificate such as that of Verisign's, for example, has been received. Alternatively, this task could be designated to an authority such as Verisign to carry out and report back on or an on-line connection to the LDAP database 22 could be used to validate the certificates.

If the result of the authentication check at 64 is positive (certificates valid), the decrypted fax document 24 is released to the intended recipient by being printed out at 62. Otherwise, the release of the document 24 is prevented at 68 and an appropriate message signifying the failure of the authentication check is presented at 69 to the person trying to access it at the receiving fax machine 16.

In this embodiment, it is also possible to configure the receiving fax machine 16 to ensure that a document is sent to a group of people and that all of the group are present before the fax document 24 is printed out. This group facility is enabled carrying out the following steps.

Firstly a session key 25 is chosen for the communication event. Then the scanned in fax document 24 to be sent is encrypted using the session key 25. The digital certificates 18 of each member of the group are obtained from the LDAP database 22 (each certificate 18 containing the members public encryption key 20). Then the session key 25 is encrypted using the public key 20 of the first member of the group. The encrypted result of this is then encrypted using the public key 20 of the second member of the group. Then the encrypted result of this is encrypted using the public key of the third member of the group and so on. This process is repeated until all of the group members' public keys 20 have been used to encode the session key 25 in this manner. The multiple encrypted session key, the encrypted fax document and the members' certificates are all sent to the receiving fax machine 16.

The receiving fax machine 16 is programmed to store each of the received certificates 18 and to request each of the intended recipients of the group to prove their identity to the receiving fax machine 16 by presentation of their respective smart cards 28 possibly within a given time period. More specifically, each of the members of the group is asked in turn to present their smart keys 28 to the receiving fax machine 16 to decrypt the multiple encrypted session key 25. The decryption is carried out on the smart card 28 itself as described previously. The order in which the members need to present their smart cards 28 to the receiving fax machine 16 is the reverse of the order for encoding the session key 25, namely starting with the last member of the group and finishing with the first. Also the decrypted result received from one member's smart card 28 is provided as the input to the next member's smart card 28 until such time as the multiple layers of encryption of the session key 25 has all been decrypted. At the end of this process, the session key 25 is decrypted correctly and can then be used to decrypt and the received fax document 24 for printing out. Accordingly, all of the intended recipients (members of the group) have to be present to enable the fax document 34 to be accessed.

As encryption techniques are used in the present embodiment, the new protocol is highly transparent. Any faxes being intercepted by an unscrupulous person or which are sent to the wrong receiving fax machine 16, would be in a secure form and would not be readily understandable by the unintended receiver. Another feature of such a protocol is that, as the documents are encoded it is not necessary to send the public key 20 of the intended recipient. Rather, the received document can be presented to anyone wishing to access the document but would only be correctly decodable by the intended recipient by use of their private key 26. As mentioned above, in order to maintain a very high level of security, all of the decoding of the received session key 25 is carried out on the smart card 28 itself. This prevents the private key 26 of the intended recipient being transferred onto the receiving machine 16 which could compromise security. Smart cards 28 can be programmed in Java to run the decryption algorithm with input/output rates up to 1 Mbit/sec.

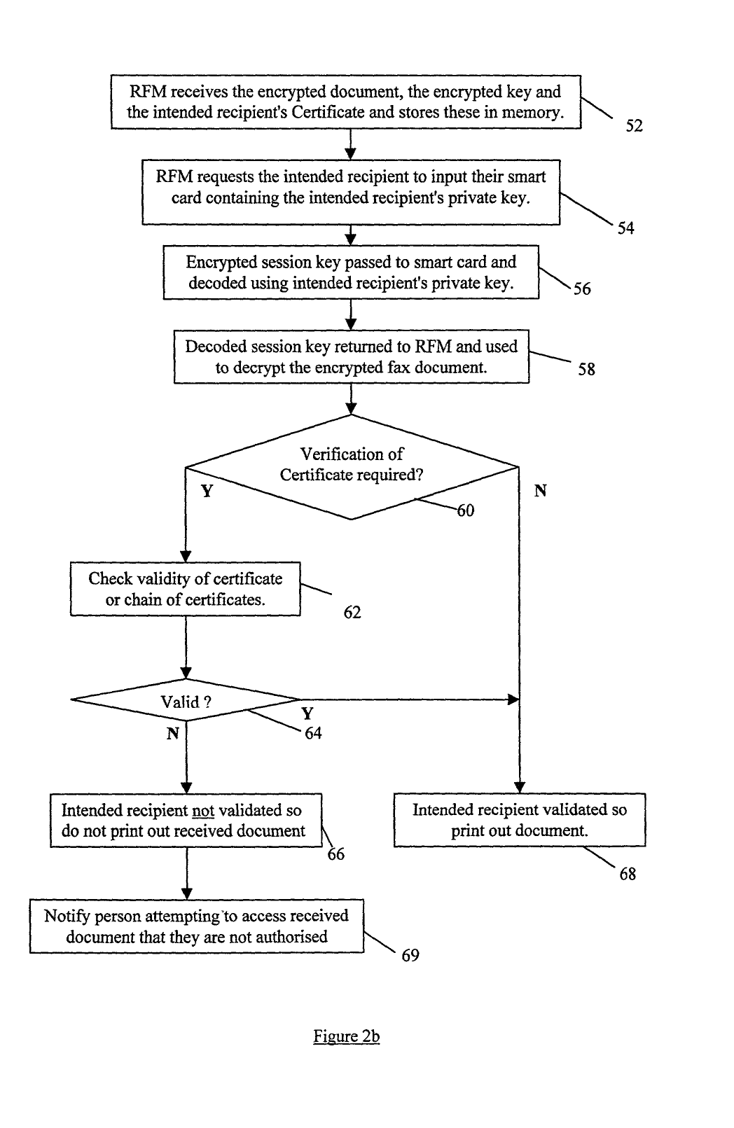

Referring now to FIG. 3, a second embodiment of the present invention is now described. The second embodiment is similar to the first and so only the differences are explained below. In this embodiment, the fax document 24 is sent to the receiving fax machine 16 in a non-encrypted format and so no session key 25 is required. On receipt of document 24, the receiving fax machine 16 prints out the received fax immediately. However, non intended recipients are prevented from reading the printed out documents 34 by virtue of them being printed out into locked compartments 36 of the receiving fax machine 16. In order to open a particular locked compartment 36, the intended recipient has once again to prove their identity by use of the smart card 28 containing their private key 26.

The way in which the intended recipient's identity can be proved is for the receiving fax machine 16 to send to the intended recipient's smart card 28 some identifier data (for example a random integer or even the intended recipient's certificate itseli) that has been encrypted by the public key 20 of the intended recipient (the public key 20 can be obtained from the received certificate 18 of the intended recipient). Then only the true intended recipient's private key 28, if present on the smart card 28, will be able to correctly decode the identifier data and provide it back to the receiving fax machine 16. The receiving fax machine 16 can determine the validity of the intended recipient by carrying out a simple comparison of the pre-encryption sent identification data and the received decrypted data. It is to be appreciated that this data is preferably data that has been sent from the sending fax machine 14 to provide greater confidence (at least to the sender) in the security of the system though it is possible that it can be generated at the receiving fax machine 16 itself. If the identifier data is generated at the receiving fax machine 16 it is encoded there using the public key 18 of the intended recipient. This advantageously reduces the amount of data being transmitted but is a less secure protocol than when the identifier data is encrypted and sent by the sending fax machine 14.

For additional security, which can also be applied to the first embodiment, the receiving fax machine 16 requests the PIN (Personal Identification Number) of the smart card holder to establish that the presenter of the card is its actual owner. The PIN is similar to that required for ATMs and is only known to the valid owner of the card. This security feature prevents a stolen card from being used to access the transmitted document 24. Alternatively, other biometrics can be used instead of the PIN, for example, signature comparison or fingerprint matching with that provided on the smart card 28, although this type of check is usually more expensive.

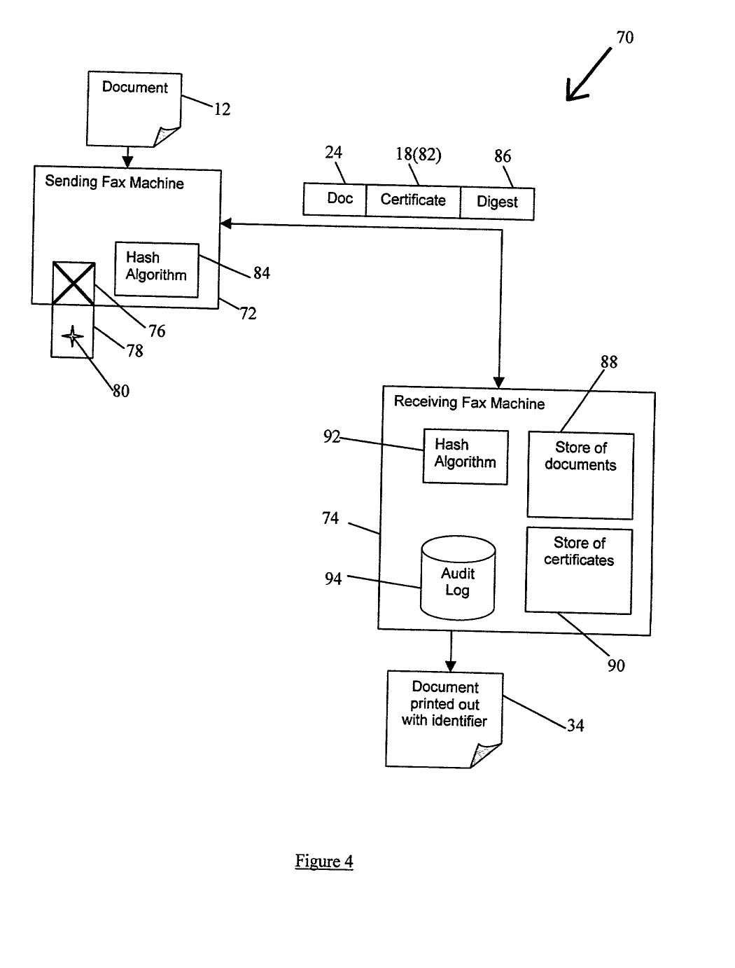

Referring now to FIGS. 4, 5 and 6, a third embodiment of the present invention is now described. This embodiment deals specifically with the issue and problems associated with an unknown sender, namely the integrity of the source of the received fax document.

A fax system 70 for implementing a new protocol for ensuring the integrity of the source of a received fax document, is now described with reference to FIG. 4. The fax system 70 comprises a sending fax machine 72 and a receiving fax machine 74. Both machines are able to function as normal fax machines but, in addition to this, are configured to take advantage of a more secure overlay protocol as is described below.

The sending fax machine 72 includes a smart card reader 76 which is arranged to receive a senders smart card 78. The smart card 78 has provided on it a private key 80 of the sender which is used to authenticate the identity of the sender as will be described later. The sending fax machine 72 also has a hash algorithm 84, such as SHA1 or MD5, provided in its memory which can be used to provide a fingerprint 86 of any block or file of data provided to it as an input. (A hash algorithm is an algorithm which reduces down a block of data into a fingerprint of about twenty bytes. It is computationally infeasible to find another document with the same fingerprint and it is not possible to derive details of the document from analysis of the fingerprint.)

Although not shown in FIG. 4, the sending fax machine 72 is connectable to a central database 22 of individuals' certificates which uses LDAP in exactly the same manner as in the first embodiment. In this way, the sending fax machine 72 is able to request and obtain the certificate 18 of a sender (rather than an intended recipient) together with their public key 82. Alternatively, the public key 82 of the sender can be obtained directly from the sender's smart card 78 or even their personal website.

The format of the data communication between the sending fax machine 72 and the receiving fax machine 74 is based on three elements, namely an electronic representation 24 of the document 12 which has been scanned into the sending fax machine 72, the certificate 18 of the sender, and an encrypted version of the document digest 86 (fingerprint of the document 12 which has been created by the hash algorithm 84). The way in which this data is used at the receiving machine is described later.

The receiving fax machine 74 has a memory in which a store 88 of documents and a store 90 of certificates is provided. These documents 24 and certificates 18 are those which have been received from the sending fax machine 72 (or other sending fax machines-not shown). The receiving fax machine 74 also has a copy of the hash algorithm 92 which is identical to the hash algorithm 84 found in the sending fax machine 72. A microprocessor (not shown) is provided for implementing the algorithm 92 and making decisions based on the comparison of data as is described in detail later.

Apart from the standard fax machine elements and functions, the receiving fax machine 74 also comprises an audit log 94 which stores information regarding the receipt of each electronic document 24. This information includes the time and date at which the fax document 24 was received, a reference to the certificate 18 which relates to the received document 24, the digest 86 of each document and a unique identifier which can be printed on each printed document 34 which establishes a link to the associated entry in the audit log 94.

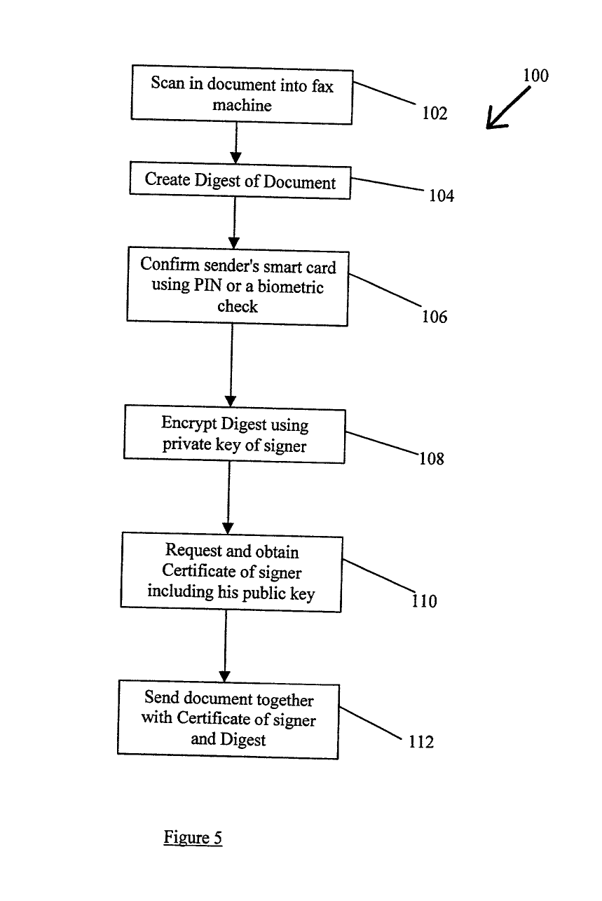

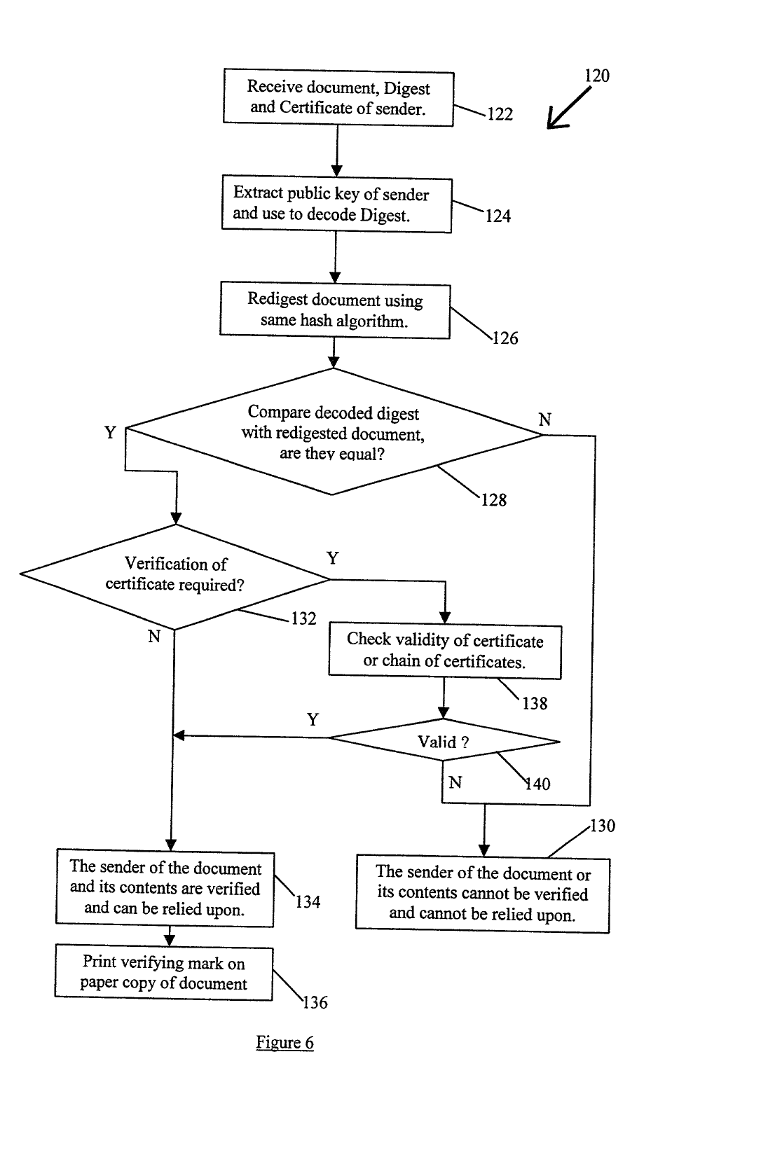

The process of transmitting a scanned in document 12 from the sending fax machine 72 (namely the fax machine of an unknown person or authority) to the receiving fax machine 74 is now described with reference to FIGS. 5 and 6.

The process is divided into two distinct parts, the first part 100 (FIG. 5) which occurs at the sending machine 72 and the second part (FIG. 6) which occurs at the receiving machine 74. Taking each of these in turn, the first part 100 commences with the document 12 being scanned at 102 into the sending fax machine 72. The hash algorithm 84 is then used at 104 to create a digest 86 of the scanned in document. The sending fax machine 72 requests the sender to input his smart card 78 and also to confirm the card by entering its associated PIN. The card 78 is entered into the smart card reader 76 and card confirmed at 106.

The private key 80 of the sender is then used at 108 to encrypt the digest 86 of the document 24. This encryption provides the link back to the sender which forms the basis for author authentication security of the present embodiment. The sending fax machine 72 also requires the sender's certificate 18 which includes the sender's public key 82 for sending to the receiving fax machine 74. Accordingly, the process 100 continues with the sending fax machine 72 requesting and obtaining at 110 the sender's certificate 18. As mentioned before, this is obtained either from the sender's smart card 78, the sender's website or from a central database such as the LDAP database 22. Finally, the document 24, the sender's certificate 82 and the encrypted digest 86 of the document are all sent at 112 to the receiving fax machine 74.

Referring now to FIG. 6, the second part 120 of the process which occurs at the receiving fax machine 74 commences with the receiving at 122 of the document 24, the sender's certificate 82 and the encrypted digest 86 of the document. The receiving fax machine 74 extracts at 124 the public key 82 of the sender from the enclosed digital certificate 18 and uses it to decode the encrypted digest 86 of the document. In addition, the received document 24 is redigested at 126 using the same hash algorithm 92 as used to create the original digest 86. The decoded digest created by the sending fax machine hash algorithm 84 and the new digested document created by the receiving machine hash algorithm 92 are then compared at 128.

If these two digests are not equivalent, then the second part 120 of the process ends at 130 with the result that sender of the document and its contents cannot be relied upon. This is caused by either the original and received documents being different or the private/public keys of the supposed sender not matching.

If these two digests are equivalent from the comparison at 128, then the process continues and determines at 132 whether validation of the sender's certificate is required. If no validation is required, then the second part 120 of the process ends at 134 with the result that sender of the document and its contents can both be relied upon. This result is then identified to the recipient by the printing at 136 of a verifying mark (not shown) on the printout 34 of the received document 24. However, if validation is required as determined at 132, then the receiving fax machine 74 takes steps at to check the validity of the certificate 18 or a chain of certificates of which the present certificate forms a part. These checks can be made on-line to higher and higher authorities and may, if necessary, extend all the way to a trusted authority such as Verisign. The process of on-line authentication of a certificate is well understood in the art and does not require further explanation herein.

The result of the verification process determines the validity of the certificate 18 and if it is valid at 140, then the second part 120 of the process ends at 134 with the result that sender of the document and its contents can both be relied upon. Otherwise, the certificate 18 is considered to be invalid at 140, and the second part 120 of the process ends at 130 with the result that sender of the document cannot be relied upon.

It is also to be appreciated that if the receiving fax machine 74 carries out the certificate validation check then it could notify the result (confirmation) in header sheet or other print form or even on screen of the receiving fax machine. Such a confirmation would identify the document, identify the sender, and signify that the relevant sender's certificate or certificates had all been verified.

Received certificates 18 are placed in the store 90 on receipt and a relevant entry is made in the audit log 94. However, as described above, a received certificate 18 is not necessarily checked on-line when a new fax is received; this decision depends on the relationship between the sender and the recipient. If at any time in future doubt should arise as to the identity of the sender of a fax, thus requiring on-line verification of the certificate, then the relevant certificates 18 listed in the audit log 94 associated with that fax can be accessed by use of the unique identifier printed on the paper copy 34 of the fax document 24. Once the relevant certificate 18 has been located, an on-line validity check can be carried out.

The above described audit log 94 advantageously allows later on-line checks to be carried out on received documents 24 and their associated certificates 18. Furthermore, the provision of the audit log 94 permits the potentially time-consuming on-line validation procedure to be carried out at a more convenient time and also to be carried out for batches of received fax documents 24 and their associated certificates 18. If batch on-line validation is carried out, significant time savings can be attainted over individual on-line validations.

As mentioned previously, a copy of the digest for each received fax is also stored in the audit log 94 for additional security. The digest can be used in conjunction with the hash algorithm 92 as described above to verify the equivalence of the received document and a copy of that document at any time in the future. This provides proof that the document has not been tampered with at any time between its receipt and the subsequent moment in time when its authenticity is being considered.

In addition, the audit log 94 provides a history of the faxes received and can at a later time provide confirmation of when a fax was sent/received and who sent it. Each page of a received and printed out fax contains the above mentioned unique validation mark on it. Accordingly, each printed page of a received fax has a page number provided and also the unique identifier which can be associated with an audit log entry so that it is possible at any time to determine from a single page who sent the fax, when it was sent and the authenticity of each page thereof.

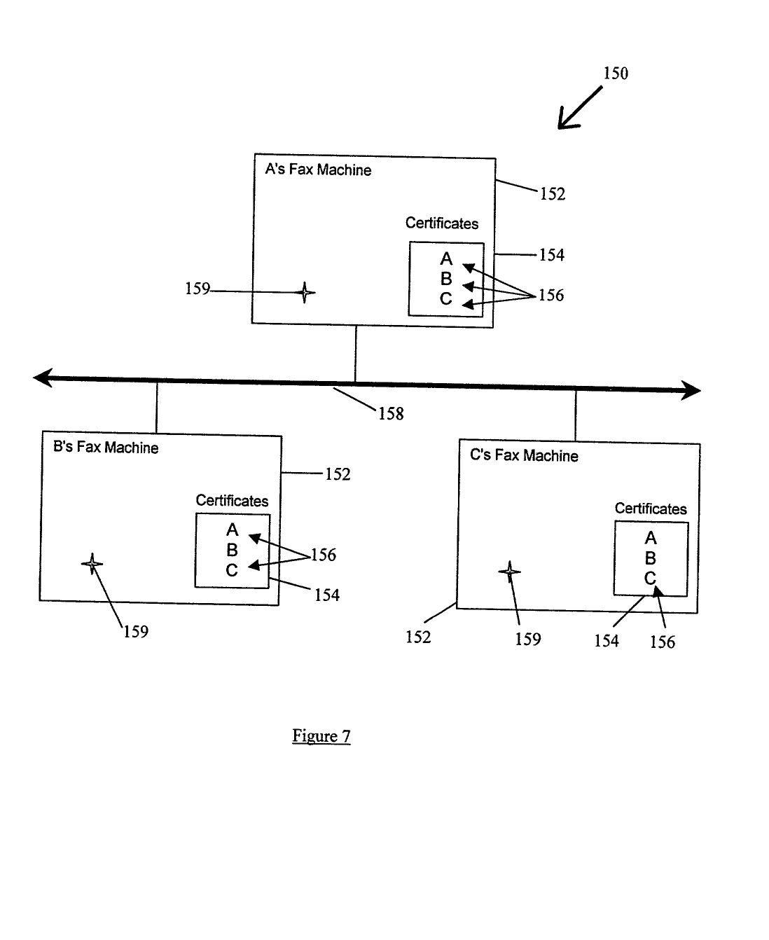

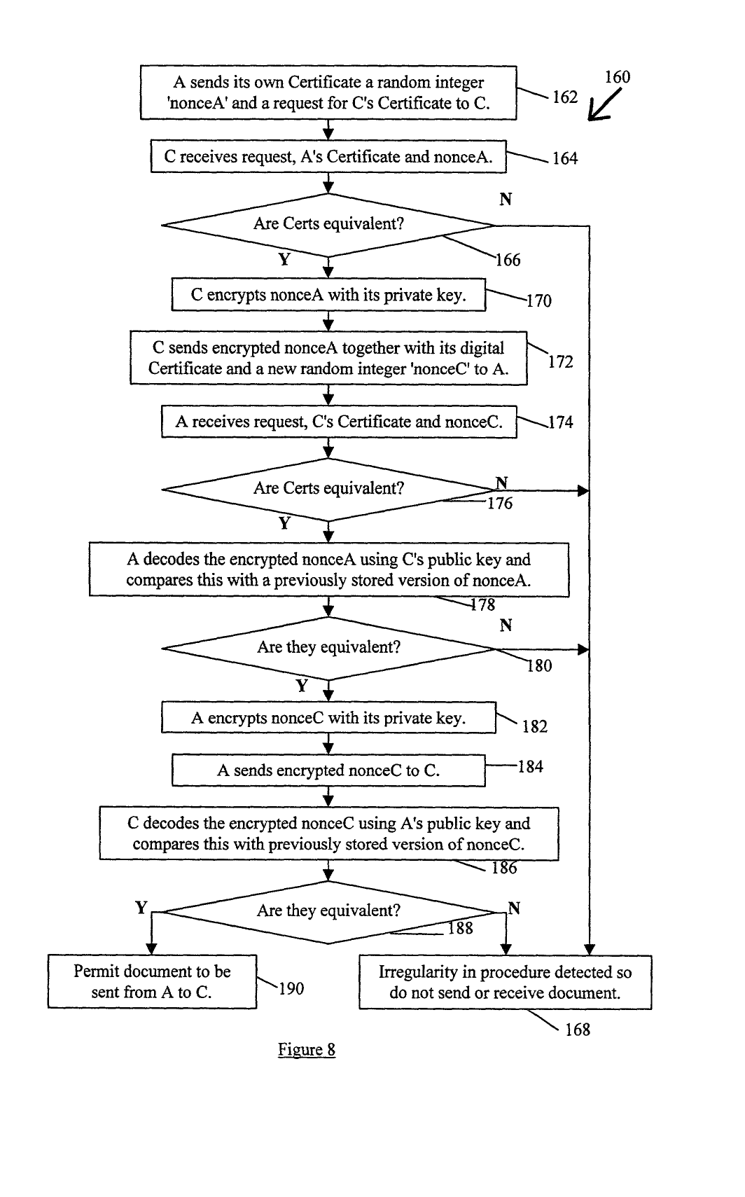

Referring now to FIGS. 7 and 8, closed group fax system 150 according to a fourth embodiment of the present invention is described. The closed group fax system 150 comprises a group of authenticated fax machines 152 (in the present embodiment a group of only three fax machines (A, B and C) is shown). These machines make up a virtual private network.

Each fax machine 152 has provided within it a store 154 of group member's certificates 156. These can be provided by any known method for example by either remote programming via the communications network 158 that links the fax machines 152 together, or by individual loading of each member's certificate 156 onto each machine 152.

The fax system 150 operates as a virtual private network by way of an authentication procedure that operates prior to the transmission of any fax document data. The authentication procedure determines whether a given pair of sending and receiving fax machines 152 are both members of the authorized group of fax machines as is now described with reference to FIG. 8 using an example of a desired transmission of a document from fax machine A to fax machine C.

The authentication procedure 160 commences with Machine A (A) sending at 162 its own digital certificate 156 together with a nonce (labeled NonceA) to Machine C (C). NonceA is a random integer that has been generated at A and that is used only once. NonceA is used in a data exchange to stop replay attacks, namely the reuse of a valid authentication for further authentications.

C receives Machine A's request at 164 together with NonceA. The received version of A's Certificate is compared at 166 with the corresponding Certificate 156 held in its store 154. If they are not equivalent, at 166, the procedure has detected an irregularity at 168 and the procedure 160 is stopped at 168. Otherwise, the procedure continues as described below.

The received NonceA is encrypted at 170 using C's private key (only available at C). This can be carried out on a smart card which holds the private key 159 as well as a encoding/decoding algorithm for example. C then generates a new nonce (labeled as NonceC) and sends this at 172 together with the encrypted NonceA and C's digital Certificate to A.

On receipt of the encrypted NonceA, C's digital Certificate and NonceC at 170, A compares at 176 the received version of C's digital Certificate with the corresponding Certificate 156 held in its store 154. If they are not equivalent, at 176, the procedure has detected an irregularity at 168 and the procedure 160 is stopped at 168. Otherwise, the procedure continues as described below.

A then decodes at 178 the encrypted NonceA using C's public key (the Public key is either obtained from C's Certificate or has previously been stored in A's memory. The decrypted version of NonceA is compared at 178 to the previously stored version of NonceA. If both versions are not equivalent at 180, then an irregularity in the authentication procedure has been detected and the subsequent transmission of a fax document between A and C is prevented at 168. Conversely, if both version are equivalent at 180, then A has proved that that the party who has sent the encrypted NonceA is the owner of C's private key, namely C and so commences its response procedure.

The response procedure commences at 182 with A encrypting the received NonceC with its own private key 159. Again the private key 159 may be provided on a smart card as in the previous embodiments. A then sends at 184 the encrypted NonceC to C. On receipt, C decodes at 186 the encrypted NonceC using A's public key (available via A's digital Certificate or previously stored) and compares this at 186 with the previously stored version of NonceC. If at 188 the decrypted version of NonceC is not equivalent to the stored original, then an irregularity in the authentication procedure 160 has been detected and the subsequent transmission of a fax document between A and C is prevented at 168. Otherwise, if both version are equivalent at 188, then C has proved that that the party who has sent the encrypted NonceC is the owner of A's private key 159, namely A. Accordingly, the authentication procedure 160 is now complete and the document can be faxed at 190 between A and C.

The use certificates 156 in the above procedure not only enables a local check to be made as to the membership of the closed group of the fax machine 152 wishing to commence communication but also enables each fax machine 152 to carry out on-line authentication checks to establish as an additional check whether each participating fax machine 152 is who it claims to be. Also this on-line authentication procedure provides an up-to-date validity check on the status of the fax machines' Certificates 156 if required.

It is to be appreciated that the above described encryption techniques can also be used with this embodiment of the present invention if additional security is required. Also prior to the authentication procedure, a person wishing to send a document using one of the authorized fax machines 152 may be required to prove their identity by the use of a personal smart card 28 containing their certificate 156 and their private key 159. This would provide an additional layer of security for the virtual private network.

An example of a typical application of the fourth embodiment of the present invention is a fax machine in a local bank that should only receive faxes from other remote branches of the same bank. Here, the certificates 156 of the fax machines 152 at the remote branches are stored in the local branch fax machine and are used to confirm the identity of the sending/receiving fax machine at the remote branch.

It is to be appreciated that the above described embodiments can all be combined in different ways to provide a system or method with significant advantages. In particular, the first or second embodiments relating to the unknown intended recipient can readily be combined with the third embodiment relating to the unknown sender. Such a combination of embodiments would provide a very secure system of fax transmission and receipt. In addition, the first or second embodiments and the third embodiment can also be combined with the fourth embodiment to provide a virtual private network with secure intended recipient and unknown sender capabilities. Similarly, other valid combinations of embodiments are the third embodiment with the fourth embodiment and also the first or second embodiments with the fourth embodiment. Furthermore, the first and second embodiments could also be combined such that the receiving fax machine could either printout decrypted documents directly or print non-encrypted documents into locked compartments. The configuration options of the receiving fax machine would be set up to determine its mode of operation with the faxes to be received.

It is also to be appreciated that the fax machines 14, 16 described in the above embodiments have provided within them a software configurable communications module (not shown) for receiving and transmitting documents and data, and a software configurable controller (not shown) for processing data (encrypting/decrypting data or implementing hash algorithms, for example) as required.

Having described particular preferred embodiments of the present invention, it is to be appreciated that the embodiments in question are exemplary only and that variations and modifications such as will occur to those possessed of the appropriate knowledge and skills may be made without departure from the spirit and scope of the invention as set forth in the appended claims. For example, the present invention is not restricted to fax documents, and could equally be applied to any transmitted document which requires printing out, for example the present invention could also apply to document printing from computers. The issues of secure document reception which require secure document reproduction to prevent any person seeing contents by accident, for example, also occur with shared printers on a network or at a hotel lobby (document transmitted from hotel room to printer in lobby).

1. A method of delivering a digital document to an intended recipient at a printout station, the method comprising:
receiving and securely retaining a transmitted document and a transmitted independently verifiable data record of the intended recipient at a printout station;
obtaining a first token of the intended recipient;
requesting proof of the intended recipient's identity at the printout station using data in the independently verifiable data record of the intended recipient; and
releasing the document when the intended recipient has proved their identity by use of a second token that is uniquely related to the first token.

2. A method according to claim 1, wherein the transmitted document is a fax document and the printout station comprises a fax machine.

3. A method according to claim 1, wherein the retaining step comprises printing out the document as received and placing it in a locked compartment.

4. A method according to claim 3, wherein the releasing step comprises unlocking the compartment where the printed copy of the document is stored.

5. A method according to claim 1, wherein the retaining step comprises storing the received document in memory without printing out a copy of it on receipt.

6. A method according to claim 5, wherein the releasing step comprises printing out a copy of it.

7. A method according to claim 1, wherein the requesting step comprises requesting supply of data encoded with the second token which can be decoded with the first token.

8. A method according to claim 1, wherein the releasing step is carried out when the intended recipient has presented a portable data carrier holding the second token to the printout station and has transferred data to prove their identity.

9. A method according to claim 8, wherein the releasing step further comprises the intended recipient entering a verifiable security identifier into the printout station to establish that they are the legitimate owner of the portable data carrier.

10. A method according to claim 8, wherein the portable data carrier is a smart card and the printout station comprises a smart card reader.

11. A method according to claim 1, wherein the obtaining step comprises extracting the first token transmitted with the document and the data record.

12. A method according to claim 11, wherein the intended recipient's independently verifiable data record is provided as an intended recipient's digital certificate.

13. A method according to claim 1, further comprising carrying out an on-line check of the validity of the intended recipient's independently verifiable data record.

14. A method according to claim 1, further comprising instructing a third party to carry out an on-line check of the validity of the intended recipient's independently verifiable data record.

15. A method according to claim 13, wherein the releasing step further comprises only releasing the document if the validity of the independently verifiable data record has been confirmed as a result of the check.

16. A method according to claim 14, wherein the releasing step further comprises only releasing the document if the validity of the independently verifiable data record has been confirmed as a result of the check.

17. A method according to claim 1, wherein the first and second tokens comprise private and public encryption/decryption keys of the intended recipient.

18. A method according to claim 1, wherein the transmitted document is encoded and the method further comprises decoding the received document once the intended recipient has proved their identity.

19. A method according to claim 18, wherein the transmitted document has been encoded using enveloping technique and the decoding step comprises using enveloping decryption techniques.

20. A method according to claim 19, wherein the transmitted document has been encoded with a session key and the session key has been encrypted with the first token,
the transmitting step comprises transmitting the encrypted session key to the printout station, and
the decoding step comprises decrypting the encrypted session key with the second token and decoding the received document with the decrypted session key.

21. A method of delivering a digital document to an intended recipient at a printout station, the method comprising:
obtaining a first token of the intended recipient;
encoding the digital document with a session key, and encrypting the session key with the first token;
transmitting and securely retaining the digital document, the encrypted session key and an independently verifiable data record of the intended recipient at a printout station;
requesting proof of the intended recipient's identity at the printout station using data in the independently verifiable data record of the intended recipient;
receiving proof of the intended recipient's identity in the form of a second token uniquely related to the first token;
decrypting the encrypted session key with the second token, decoding the digital document with the decrypted session key, and releasing the document.

22. A method according to claim 21, wherein the transmitted document is a fax document and the printout station comprises a fax machine.

23. A method according to claim 21, wherein the retaining step comprises printing out the document as received and placing it in a locked compartment.

24. A method according to claim 23, wherein the releasing step comprises unlocking the compartment where the printed copy of the document is stored.

25. A method according to claim 21, wherein the retaining step comprises storing the received document in memory without printing out a copy of it on receipt.

26. A method according to claim 25, wherein the releasing step comprises printing out a copy of it.

27. A method according to claim 21, wherein the requesting step comprises requesting supply of data encoded with the second token which can be decoded with the first token.

28. A method according to claim 21 wherein the releasing step is carried out when the intended recipient has presented a portable data carrier holding the second token to the printout station and has transferred data to prove their identity.

29. A method according to claim 28, wherein the releasing step further comprises the intended recipient entering a verifiable security identifier into the printout station to establish that they are the legitimate owner of the portable data carrier.

30. A method according to claim 28, wherein the portable data carrier is a smart card and the printout station comprises a smart card reader.

31. A method according to claim 21, wherein the obtaining step comprises extracting the first token transmitted with the document and the data record.

32. A method according to claim 31, wherein the intended recipient's independently verifiable data record is provided as an intended recipient's digital certificate.

33. A method according to claim 21, further comprising carrying out an on-line check of the validity of the intended recipient's independently verifiable data record.

34. A method according to claim 21, further comprising instructing a third party to carry out an on-line check of the validity of the intended recipient's independently verifiable data record.

35. A method of according to claim 33, wherein the releasing step further comprises only releasing the document if the validity of the independently verifiable data record has been confirmed as a result of the check.

36. A method according to claim 34, wherein the releasing step further comprises only releasing the document if the validity of the independently verifiable data record has been confirmed as a result of the check.

37. A method according to claim 21, wherein the first and second tokens comprise private and public encryption/decryption keys of the intended recipient.

38. A method according to claim 21, wherein the receiving step comprises receiving a plurality of transmitted independently verifiable data records of the intended recipients at the printout station;
the obtaining step comprises obtaining the first tokens of each of the intended recipients;
the requesting step comprises requesting proof of each of the intended recipients' identities at the printout station using data in the independently verifiable data records of the intended recipients; and
the processing step comprises processing each of the intended recipients' response to the request and releasing the document when all of the intended recipients have proved their identity by use of respective second tokens that are each uniquely related to respective ones of the first tokens.

39. A method according to claim 38, wherein the transmitted document or a session encryption/decryption key of the transmitted document has been sequentially encrypted with each of the first tokens of the intended recipients in a given order and the processing step comprises sequentially decrypting the transmitted document or a session encryption/decryption key with each of the second tokens of the intended recipients in the reverse of the given sequential order.

40. A method of delivering a digital document to intended recipients at a printout station, the method comprising:
receiving and securely retaining a transmitted document and a plurality of independently verifiable data records of the intended recipients at the printout station;
obtaining first tokens of each of the intended recipients;
requesting proof of each of the intended recipient's identities at the printout station using data in the independently verifiable data records of the intended recipients; and
processing each of the intended recipients' responses to the request for proof and releasing the document when all of the intended recipients have proved their identity by use of respective record tokens that are each uniquely related to respective ones of the first tokens.

41. A device for delivering a digital document to an intended recipient, the device comprising:
a communications module for receiving an electronic version of the transmitted document over a communications network, an independently verifiable data record of the intended recipient, and a first token of the intended recipient;
a store for securely retaining the transmitted document, the transmitted independently verifiable data record and the first token;
an instruction module for requesting proof of the intended recipient's identity using data provided in the intended recipient's data record;
a controller for releasing the document when the intended recipient has proved their identity by use of a second token that is uniquely related to the first token; and
a portable data carrier reader for receiving information from a portable data carrier storing the intended recipient's second token.

42. A device according to claim 41, wherein the device comprises a fax machine.

43. A device according to claim 41, wherein the first and second tokens comprise private and public encryption/decryption keys of the intended recipient.

44. A device according to claim 41, further comprising one or more lockable compartments and the device is arranged to print out the document as received and place it in one of the compartments.

45. A device according to claim 44, wherein the controller is arranged to release the locked compartment containing the document, once the intended recipient has proved their identity.

46. A device according to claim 41, wherein the store is arranged to retain securely the received document without printing out a copy of it on receipt.

47. A device according to claim 46, wherein the controller is arranged to release the document from the store and to print out a copy of it, once the intended recipient has proved their identity.

48. A device according to claim 41, wherein the controller is arranged to release the received document when the intended recipient has entered a verifiable security identifier into the printout station to establish that they are the legitimate owner of the portable data carrier.

49. A device for delivering a digital document to an intended recipient, the device comprising:
a communications module for receiving an electronic version of the transmitted document over a communications network, an independently verifiable data record of the intended recipient, and a first token of the intended recipient;
a store for securely retaining the transmitted document, the transmitted independently verifiable data record and the first token;
an instruction module for requesting proof of the intended recipient's identity using data provided in the intended recipient's data record;
a controller for releasing the document when the intended recipient has proved their identity by use of a second token that is uniquely related to the first token; and
one or more lockable compartments and the device is arranged to print out the document as received and place it in one of the compartments.

50. A device according to claim 49, wherein the controller is arranged to release the locked compartment containing the document, once the intended recipient has proved their identity.

51. A device according to claim 49, wherein the device comprises a fax machine.

52. A device according to claim 49, wherein the first and second tokens comprise private and public encryption/decryption keys of the intended recipient.

53. A device according to claim 49, wherein the controller is arranged to release the received document when the intended recipient has entered a verifiable security identifier into the printout station to establish that they are the legitimate owner of a portable data carrier.

54. A method of delivering a digital document from a first station via a communications network to an intended recipient at a second station, the method comprising:
obtaining details of the intended recipient, including an independently verifiable data record of the intended recipient at the first station;
determining prior to transmission of the document whether the second station is one which is arranged to implement the present method;
transmitting the document and the independently verifiable data record of the intended recipient to the second station;
receiving and securely retaining the transmitted document and data record at the second station;
obtaining a first part of an intended recipient's identifying token at the second station;
requesting proof of the intended recipient's identity at the second station using the transmitted independently verifiable data record; and
releasing the document to the intended recipient when the intended recipient has proved their identity using a second part of the recipient's identifying token

55. A method according to claim 54, further comprising obtaining details of the intended recipient including the independently verifiable data record prior to transmitting the document.

56. A method according to claim 55 wherein the step of obtaining details comprises obtaining the independently verifiable data record from a central database storing many possible intended recipients' details.

57. A method according to any of claim 54, wherein the intended recipient's independently verifiable data record is provided in an intended recipient's digital certificate.

58. A method according to any of claim 54, further comprising encoding the document prior to transmitting it to the second station and decoding the received document once the intended recipient has proved their identity.

59. A method according to claim 58, wherein the encoding/decoding steps comprise using enveloping encryption/decryption techniques.

60. A method of delivering a digital document from a first station via a communications network to an intended recipient at a second station, the method comprising:
obtaining details of the intended recipient, including an independently verifiable data record of the intended recipient at the first station, encoding the document using encryption techniques prior to transmitting it to the second station;
transmitting the document and the independently verifiable data record of the intended recipient to the second station;
receiving and securely retaining the transmitted document and data record at the second station;
obtaining a first part of an intended recipient's identifying token at the second station;
requesting proof of the intended recipient's identity at the second station using the transmitted independently verifiable data record; and
decoding the received document using decryption techniques and releasing the document to the intended recipient when the intended recipient has proved their identity using a second part of the recipient's identifying token.

61. A method according to claim 60, further comprising obtaining details of the intended recipient including the independently verifiable data record prior to transmitting the document.

62. A method according to claim 61, wherein the step of obtaining details comprises obtaining the independently verifiable data record from a central database storing many possible intended recipients' details.

63. A method according to claim 60, wherein the intended recipient's independently verifiable data record is provided in an intended recipient's digital certificate.
